(19) United States
(12) Patent Application Publication
(10) Pub. No.: US 2025/0011234 A1
(43) Pub. Date: Jan. 9, 2025

(54) METHOD FOR PREPARING CONSTRUCTION MATERIAL FOR ROADBED AND PAVEMENT BY USING CONSTRUCTION SOLID WASTE-BASED GEOPOLYMERS

(71) Applicant: Xi’an Research and Design Institute of Wall &Roof Materials Co.,Ltd., Xi’an (CN)

(72) Inventors: Zonggang Quan, Xi'an (CN); Dong Liang, Xi'an (CN); Yuanyuan Chen, Xi'an (CN); Keying Wang, Xi'an (CN); Yunning Zhang, Xi'an (CN)

(21) Appl. No.: 18/755,612

(22) Filed: Jun. 26, 2024

(30) Foreign Application Priority Data
Jul. 7, 2023 (CN) 202310833907.5

(51) Int. Cl. C04B 18/167; C04B 14/06; C04B 22/06; C04B 28/08; C04B 40/00; C04B 111/00

(52) U.S. Cl. CPC C04B 18/167; C04B 14/06; C04B 22/064; C04B 22/068; C04B 28/08; C04B 40/0039; C04B 2111/0075

(57) ABSTRACT

A method for preparing a construction material for a roadbed and a pavement by using construction solid waste-based geopolymers includes: preparing a construction solid waste-based geopolymer cementitious material and construction solid waste-based recycled sand by using construction solid wastes, and then preparing the construction material by batching, stirring, molding, and curing the cementitious material and the recycled sand with aggregates and water. Barium hydroxide is determined as a main activator and a high-pressure activation is performed, thereby promoting a dissolution efficiency of active silicon and aluminum in the construction solid wastes; and a compensator is added to promote polymerization to obtain the cementitious material with a compact three-dimensional network structure. The recycled sand is also obtained, and the construction material is obtained by using the recycled sand and the cementitious material, thereby fully utilizing the construction solid wastes and improving preparation efficiency of the construction material.

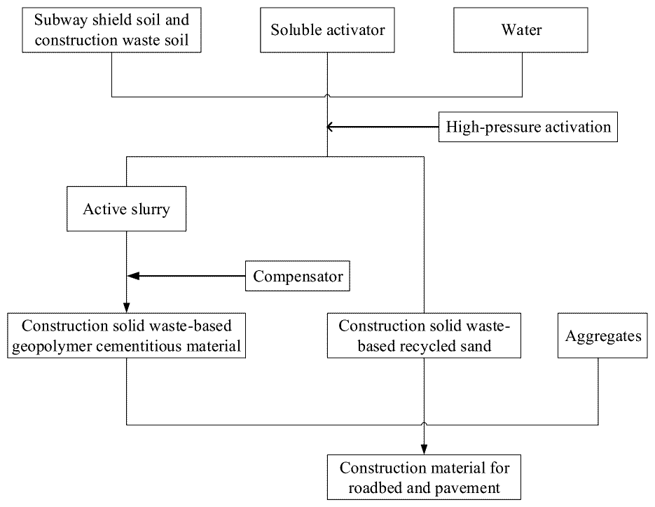

### CROSS-REFERENCE TO RELATED APPLICATION

This application claims priority to a Chinese patent application No. 202310833907.5, filed to China National Intellectual Property Administration (CNIPA) on Jul. 7, 2023, which is herein incorporated by reference in its entirety.

### TECHNICAL FIELD

The present disclosure relates to the technical field of resource utilization of construction solid wastes, particularly to a method for preparing a construction material for a roadbed and a pavement by using construction solid waste-based geopolymers.

### BACKGROUND

Geopolymer (also known as inorganic polymer, abbreviated as geopolymer) is an amorphous cementitious material with a three-dimensional network structure composed of silicon oxide tetrahedra and aluminum oxide tetrahedra. Geopolymer materials have received widespread attention in the past few decades due to their excellent mechanical properties, chemical stability, and high-temperature resistance.

Geopolymers are usually made from active silicon-aluminum-rich materials as the main raw material, which are prepared by stirring, mixing, shaping, and curing under the action of alkaline activators. Thereafter, the three-dimensional network structure of cementitious materials is formed through a series of complex reactions: dissolution of silicon aluminum raw materials, depolymerization of aluminum oxide tetrahedra and silicon oxide tetrahedra, and re-condensation of aluminum oxide tetrahedra and silicon oxide tetrahedra. Specially, a metakaolin-sodium silicate/sodium hydroxide system has the best properties.

Usually, the active silicon aluminum materials use metakaolin, which is mainly prepared by lightly calcining kaolin. The main alkaline activators are sodium silicate and sodium hydroxide. The geopolymer products of this system have excellent performance and good mechanical and durability indicators. However, the metakaolin is still an industrial waste activation process, and compared with the production process of sodium silicate, the two are two parallel routes in the process of geopolymer preparation, which means they require two rounds of energy consumption. So if these two processes can be integrated and unified, it will greatly reduce the application threshold of geopolymer.

At present, many scholars are looking for alternatives to the metakaolin, such as fly ash, slag, red mud, and mineral waste residue. After activation, the above alternatives have achieved varying degrees of breakthroughs in the application of the geopolymers. However, the dependence on sodium silicate is still unresolved.

In an early research stage on the construction solid wastes (i.e., construction waste soil and subway shield soil), it is found that muscovite, phlogopite, and montmorillonite have properties similar to kaolin after treatment, and can be used for preparing the geopolymer. But a difficulty lies in that chemical compositions of the construction solid wastes are complex (i.e., construction waste soil and subway shield soil). Furthermore, an analysis is performed on the chemical compositions of the construction solid wastes in some areas, and it is found that a total content of kaolinite, muscovite, phlogopite, and montmorillonite in the chemical compositions of the construction solid wastes is between 20% and 40%, but a content of quartz is also between 40% and 60%. If the light calcining process is used, the activation of quartz is impossible unless an enrichment of potential active materials is completed in advance. In addition, the light calcining process is not ideal for the activation of materials with complex mineral compositions.

Therefore, an ideal technical solution is to activate the two types of minerals in the construction solid wastes (i.e., construction waste soil and subway shield soil) by the same process; and then auxiliary conditioners are added and stirred to be directly used to prepare a geopolymer cementitious material. A difficulty for preparing the geopolymer cementitious material lies in a ratio of silicon, aluminum, and alkali, as well as reaction conditions in the activation process. Moreover, if the ratio is not suitable for the polymerization reaction during the activation process, the ideal geopolymer cementitious material cannot be obtained.

### SUMMARY

A technical problem to be solved by the present disclosure is to provide a method for preparing a construction material for a roadbed and a pavement by using construction solid waste-based geopolymers, which aims at the deficiencies in the related art. According to the method, construction solid wastes are used as raw materials, barium hydroxide (Ba(OH)₂) is used as a main activator to perform a high-pressure activation on the construction solid wastes, thereby promoting a dissolution efficiency of active silicon aluminum, and then a cementitious material with a mass-dense three-dimensional network structure with sodium ions and calcium ions as central cations is obtained in combination with an addition of a compensator. Meanwhile, construction solid waste-based recycled sand is also obtained. Thereafter, the cementitious material and the construction solid waste-based recycled sand are applied to preparing the construction material for the roadbed and the pavement, so that the construction solid wastes are fully utilized, and the problem of difficult activation of the existing construction solid wastes is solved.

In order to solve the above technical problem, a technical solution adopted by the present disclosure is as follows. The method for preparing the construction material for the roadbed and the pavement by using the construction solid waste-based geopolymers includes the following steps: preparing a construction solid waste-based geopolymer cementitious material and construction solid waste-based recycled sand by using the construction solid wastes, and then preparing the construction material for the roadbed and the pavement by batching, stirring, molding, and curing the construction solid waste-based geopolymer cementitious material and the construction solid waste-based recycled sand with aggregates and water. The construction material for the roadbed and the pavement includes: a railway sleeper, a road imitation brick, and a road water-permeable brick.

In the method for preparing the construction material for the roadbed and the pavement by using the construction solid waste-based geopolymers, raw materials for preparing the construction solid waste-based geopolymer cementitious material and the construction solid waste-based recycled sand are obtained from subway shield soil or construction waste soil in the construction solid wastes; and mineral compositions in the raw materials include: muscovite, phlogopite, montmorillonite, and quartz with a total mass content greater than 60%; and a mass content of silica (SiO₂) in chemical compositions of the raw materials is greater than 50%, and a mass content of aluminum oxide (Al₂O₃) in the chemical compositions of the raw materials is not less than 15%.

In the method for preparing the construction material for the roadbed and the pavement by using the construction solid waste-based geopolymers, the construction solid waste-based geopolymer cementitious material is prepared by batching, mixing, and stirring active slurry and a compensator; a soluble activator added in the active slurry is barium hydroxide and hydrogen peroxide, or barium hydroxide, hydrogen peroxide, and sodium hydroxide; and the compensator includes: sodium ions, calcium ions, and aluminum ions; and the active slurry is prepared by the following steps:
step 1, raw material screening, comprising: screening the construction solid wastes through sieves with each aperture of 1 millimeters (mm) to obtain undersize particles and oversize particles, and using the oversize particles to obtain the construction solid waste-based recycled sand;
step 2, stirring, including: adding the soluble activator into water, uniformly stirring the water added with the soluble activator, and then standing for more than 2 hours (h) to obtain a pre-added solution with a concentration of 200 grams per liter (g/L), mixing the undersize particles obtained in the step 1 with the pre-added solution, and stirring the pre-added solution mixed with the undersize particles by using a high-speed disperser to obtain a prepared slurry; a stirring speed of the high-speed disperser being 3,000 revolutions per minute (rpm), and a time for the stirring in the step 2 being 20 minutes (min);
step 3, high-pressure activation, including: adding the prepared slurry obtained in the step 2 in a reaction kettle for the high-pressure activation to obtain activated mixed slurry; a temperature of the high-pressure activation in the step 3 being in a range of 120 degrees Celsius (° C.) to 150° C.; a pressure of the high-pressure activation in the step 3 being in a range of 0.2 megapascals (MPa) to 0.5 MPa; and a time for maintaining the pressure being 2 h; and
step 4, slurry sand separation, including: sieving the activated mixed slurry obtained in the step 3 through a 180-mesh sieve to obtain the active slurry and sieve residues, and using the sieve residues to prepare the construction solid waste-based recycled sand.

Silicate clay minerals and quartz are dissolved out under the alkaline condition and then polymerized with the central cations to form the three-dimensional network structure. The research of the present disclosure has found that, from a perspective of prepared product (i.e., the construction material), potassium ions, sodium ions, and calcium ions are the best choices for the central cations, and the mechanical properties of the prepared product are relatively excellent. However, the hydroxide of calcium is insoluble, thereby failing to be applied. Specially, sodium has the strongest ability to bind silicon and aluminum, and the hydroxide thereof is easily soluble in water, so that the hydroxide of sodium is better to use.

Meanwhile, in view of the general geopolymers, the metakaolin is used as a raw material, sodium silicate and sodium hydroxide are used as the activators, and the substantial effect of sodium silicate is to provide silicon with better activity (compared with the metakaolin) to induce the polymerization reaction. The metakaolin needs to be activated at an environment that has a high temperature, is non-alkaline, and has no central cations; but a solution of the sodium silicate is alkaline, without active aluminum or central cations. Therefore, using the sodium hydroxide as the alkali to simultaneously activate the silicon and aluminum, the activation phase undergoes a polymerization reaction.

Based on the above research results, the present disclosure adopts the soluble alkali, i.e., the Ba(OH)₂ as the main activator. Due to that the barium is weak in binding with the active silicon aluminum, the stability of the geopolymer cementitious material with the three-dimensional network structure generated after the polymerization reaction is poor. In other words, most of the active silicon aluminum is not polymerized with the central cations, or the degree of polymerization is very low. At the same time, using a hydrogen peroxide inhibitor that can provide the alkaline environment or using the sodium hydroxide as an auxiliary activator, a potential of hydrogen (pH) value is adjusted to suppress the polymerization reaction, and the high-pressure activation is used to increase the dissolution efficiency of active silicon aluminum, thereby achieving simultaneous activation of silicon and aluminum in the alkaline environment and obtaining the active slurry.

Meanwhile, according to the present disclosure, the compensator containing the sodium ions, the calcium ions, and the aluminum ions is added into the active slurry, and the water is added to suitably adjust the pH value of the active slurry, thereby completing the polymerization to generate the geopolymer cementitious material with the mass-dense three-dimensional network structure with the sodium ions and the calcium ions as the central cations.

In the method for preparing the construction material for the roadbed and the pavement by using the construction solid waste-based geopolymers as described above, the compensator is prepared from at least one selected from the group consisting of gasification slag, fly ash, and slag, and a mass content of Al₂O₃ in the compensator is greater than 15%, a mass content of calcium oxide (CaO) in the compensator is greater than 10%, a mass content of sodium oxide (Na₂O) in the compensator is greater than 3%, and a gradation of the compensator is less than 180 mesh.

Due to the fact that the content of clay minerals in most of the raw materials of the construction solid wastes is not large, and the performance is not excellent after activating the construction solid wastes, the compensator composed of the above compositions has activity, and can be used as a geopolymer main material, which mainly compensates the active silicon and aluminum to reinforce the performance of the prepared product. Furthermore, calcium and sodium are introduced to replace the unstable barium in the active slurry, so that the relatively dense and stable structure is generated, and the quality of the construction solid waste-based geopolymer cementitious material is improved. In addition, the compensator of the present disclosure only needs to provide a certain amount of sodium, calcium and aluminum, which comes from the gasification slag, the fly ash and the slag. Therefore, the utilization of construction solid wastes is realized and raw material costs are reduced.

In the method for preparing the construction material for the roadbed and the pavement by using the construction solid waste-based geopolymers as described above, a method for preparing the construction solid waste-based geopolymer cementitious material by batching, mixing, and stirring the active slurry and the compensator includes the following steps:
step 1, respectively calculating amounts of the active slurry and the compensator according to design requirements of the construction solid waste-based geopolymer cementitious material, a mass ratio of the active slurry to the compensator being in a range of 1.1-1.4:1; and
step 2, weighing the active slurry according to the amount of the active slurry calculated in the step 1, pre-stirring the active slurry by using a disperser for 30 seconds (s), and then adding the compensator into the active slurry to continue stirring for 10 min to prepare the construction solid waste-based geopolymer cementitious material.

The construction solid waste-based geopolymer cementitious material is used to prepare the construction material for the roadbed and the pavement within 3 min; or the construction solid waste-based geopolymer cementitious material is stirred for another 5 min again by using the disperser at a rotating speed of 1,800 rpm, and then is used to prepare the construction material for the roadbed and the pavement.

In the batching process of the present disclosure, the amount of the active slurry and the amount of the compensator are generally proportioned according to the design requirements of the construction solid waste-based geopolymer cementitious material, and a ratio among the silicon, the aluminum, and the alkali in the active slurry is adjusted through the compensator, thereby adjusting the speed and degree of the polymerization reaction for preparing the construction solid waste-based geopolymer cementitious material, and controlling the strength and other properties of the construction solid waste-based geopolymer cementitious material.

In addition, the present disclosure strictly limits the time from preparing the construction solid waste-based geopolymer cementitious material to its application to ensure the properties of the construction solid waste-based geopolymer cementitious material.

In the method for preparing the construction material for the roadbed and the pavement by using the construction solid waste-based geopolymers, a mass ratio of the aggregates to the construction solid waste-based geopolymer cementitious material is in a range of 1.9-2.3:1.

When the construction material for the roadbed and the pavement is a high-strength railway sleeper (also referred to the railway sleeper), the aggregates include: stones with particle sizes of 5-10 mm and stones with particle sizes of 10-20 mm, a mass ratio of the stones with particle sizes of 5-10 mm to the stones with particle sizes of 10-20 mm is 3:7, and a sand to aggregate ratio of the high-strength railway sleeper is 0.5, and the compensator used for preparing the construction solid waste-based geopolymer cementitious material is fly ash,

When the construction material for the roadbed and the pavement is the road imitation brick, the aggregates include: stones with particle sizes of 3-5 mm, a sand to aggregate ratio of the road imitation brick is 0.8, the compensator used for preparing the construction solid waste-based geopolymer cementitious material is gasification slag, and a curing condition for preparing the road imitation brick is natural curing.

When the construction material for the roadbed and the pavement is the road water-permeable brick, the aggregates include: stones with particle sizes of 8-15 mm, a sand to aggregate ratio of the road water-permeable brick is 0.4, the compensator used for preparing the construction solid waste-based geopolymer cementitious material is slag, and a curing condition for preparing the road water-permeable brick is natural curing.

Compared with the related art, the present disclosure has the following advantages.

1. According to the present disclosure, the construction solid waste-based geopolymer cementitious material and the construction solid waste-based recycled sand prepared by using the construction solid wastes are batched, stirred, molded, and cured with the aggregates and water to prepare the construction material for the roadbed and the pavement, so that the construction solid wastes are fully utilized, and the resource waster is avoided.

2. According to the present disclosure, the construction solid wastes are used as the raw materials, the Ba(OH)₂ is used as the main activator and subjected to the high-pressure activation, thereby promoting the dissolution efficiency of active silicon aluminum, and the polymerization is completed by combining with the compensator to prepare the cementitious material with the mass-dense three-dimensional network structure taking the sodium ions and the calcium ions as the central cations. Therefore, the present disclosure realizes preparing the construction solid waste-based geopolymer cementitious material by using the construction solid wastes, and also prepares the construction solid waste-based recycled sand through the activation, so that the preparation efficiency is improved, and secondary energy consumption is avoided.

3. In the present disclosure, the compensator derived from wastes such as the gasification slag, the fly ash, and the slag participates in preparing the construction solid waste-based geopolymer cementitious material, so that the utilization of construction solid wastes is realized, and the raw material costs are reduced.

4. In the present disclosure, the construction solid waste-based geopolymer cementitious material and the construction solid waste-based recycled sand are prepared by using the construction solid wastes as the raw materials, the preparation process does not depend on non-renewable limestone resources, consumption of resources is reduced, and the construction solid waste-based geopolymer cementitious material is a green construction material.

5. The construction solid waste-based geopolymer cementitious material prepared by the present disclosure has characteristics of high early-strength, fast curing time, and fast hardening, and has good mechanical properties; at the same time, ettringite and other sulphoaluminate minerals are not generated during the hydration, so that the construction solid waste-based geopolymer cementitious material can resist sulfate corrosion, shows good stability in an acidic solution and various organic solvents, has excellent durability and corrosion resistance, and is suitable for preparing the construction material for the roadbed and the pavement.

6. The construction solid waste-based geopolymer cementitious material prepared by the present disclosure can form a compact structure, and has high strength and excellent impermeability; and an electrolyte concentration in the pore solution thereof is high, so that the capacity of the freeze-thaw resistance cycle is enhanced. Therefore, the construction solid waste-based geopolymer cementitious material is particularly suitable for preparing the construction material for the roadbed and the pavement under extreme temperature conditions.

7. A basic structure of the construction solid waste-based geopolymer cementitious material prepared by the present disclosure is a three-dimensional zeolite-like cage network structure composed of the silicon tetrahedron and the aluminum oxide tetrahedron. Moreover, the basic structure can effectively cure heavy metals through chemical bonds and physical adsorption, has strong ability to fix toxic metal ions, has a fixed rate of 90% or more for ions of mercury (Hg), arsenic (As), iron (Fe), manganese (Mn), chromium (Ar), cobalt (Co), and lead (Pb), and the “cage-type” network skeleton is relatively stable even under the action of nuclear radiation. Therefore, the construction solid waste-based geopolymer cementitious material is suitable for preparing the construction material for the roadbed and the pavement used in an area with heavy metal pollution and even a nuclear radiation zone.

### BRIEF DESCRIPTION OF DRAWING

The technical solution of the present disclosure will be further described in detail below with reference to an attached drawing and embodiments.

FIGURE illustrates a process flow diagram for preparing a construction material for a roadbed and a pavement by using construction solid waste-based geopolymers according to the present disclosure.

### DETAILED DESCRIPTION OF EMBODIMENTS

Construction solid wastes used in embodiments 1-3 of the present disclosure are obtained from subway shield soil and construction waste soil in Guangzhou, and raw materials of a compensator used in the embodiments 1-3 of the present disclosure are obtained from gasification slag, fly ash, and slag at Inner Mongolia. Moreover, contents corresponding to chemical compositions and mineral compositions of the construction solid wastes and the compensator are shown in the following Table 1 to Table 7.

Table 1 illustrates the chemical compositions of the subway shield soil as follows:

| | | | | | | | | | | Loss on |
|---|---|---|---|---|---|---|---|---|---|---|
| Composition | SiO₂ | Al₂O₃ | Fe₂O₃ | CaO | MgO | K₂O | Na₂O | SO₃ | TiO₂ | ignition |
| Content (%) | 59.68 | 22.05 | 2.11 | 0.26 | 0.54 | 2.25 | 0.40 | 0.41 | 1.05 | 11.10 |

Table 2 illustrates the mineral compositions of the subway shield soil as follows:

| Mineral | | | | | | |
|---|---|---|---|---|---|---|
| composition | Quartz | Phlogopite | Muscovite | Chlorite | Montmorillonite | Other |
| Content (%) | 17 | 20 | 28 | 16 | — | 19 |

Table 3 illustrates the chemical compositions of the construction waste soil as follows:

| | | | | | | | | | | Loss on |
|---|---|---|---|---|---|---|---|---|---|---|
| Composition | SiO₂ | Al₂O₃ | Fe₂O₃ | CaO | MgO | K₂O | Na₂O | SO₃ | TiO₂ | ignition |
| Content (%) | 50.75 | 21.59 | 10.64 | 0.24 | 0.59 | 2.54 | 1.23 | 0.41 | 0.68 | 10.11 |

Table 4 illustrates the mineral compositions of the construction waste soil as follows:

| Mineral | | | | | | |
|---|---|---|---|---|---|---|
| composition | Quartz | Phlogopite | Muscovite | Chlorite | Montmorillonite | Other |
| Content (%) | 45 | 16 | 11 | 22 | 4 | 15 |

Table 5 illustrates the chemical compositions of the gasification slag as follows:

| | | | | | | | | | | Loss on |
|---|---|---|---|---|---|---|---|---|---|---|
| Composition | SiO₂ | Al₂O₃ | Fe₂O₃ | CaO | MgO | K₂O | Na₂O | SO₃ | TiO₂ | ignition |
| Content (%) | 45.94 | 15.00 | 5.05 | 20.63 | 1.72 | 0.61 | 4.39 | 1.08 | 0.82 | 0.03 |

Table 6 illustrates the chemical compositions of the fly ash as follows:

| | | | | | | | | | | Loss on |
|---|---|---|---|---|---|---|---|---|---|---|
| Composition | SiO₂ | Al₂O₃ | Fe₂O₃ | CaO | MgO | K₂O | Na₂O | SO₃ | TiO₂ | ignition |
| Content (%) | 50.84 | 15.27 | 4.33 | 15.08 | 1.11 | 1.31 | 1.29 | 3.68 | 0.93 | 1.83 |

Table 7 illustrates the chemical compositions of the slag as follows:

| | | | | | | | | | | Loss on |
|---|---|---|---|---|---|---|---|---|---|---|
| Composition | SiO₂ | Al₂O₃ | Fe₂O₃ | CaO | MgO | K₂O | Na₂O | SO₃ | TiO₂ | ignition |
| Content (%) | 56.19 | 15.37 | 2.99 | 14.73 | 1.14 | 1 | 2.82 | 0.26 | 0.75 | 0.52 |

### Embodiment 1

As shown in FIGURE, in the present embodiment, the subway shield soil and the construction waste soil in the construction solid wastes are used as raw materials to prepare a construction solid waste-based geopolymer cementitious material and construction solid waste-based recycled sand, a mass ratio of the subway shield soil to the construction waste soil 1:1, and then the construction solid waste-based geopolymer cementitious material and the construction solid waste-based recycled sand are subjected to batching, stirring, molding, and curing to obtain a high-strength railway sleeper.

Specially, active slurry used in the construction solid waste-based geopolymer cementitious material is prepared as follows.

Step 1, raw material screening: the raw materials in the construction solid wastes are screened through sieves with an each aperture of 1 millimeters (mm) to obtain undersize particles and oversize particles, and the oversize particles are used to obtain the construction solid waste-based recycled sand.

Step 2, stirring: barium hydroxide and hydrogen peroxide with a mass concentration of 6% are prepared as a soluble activator, a mass ratio of the barium hydroxide to the hydrogen peroxide in the soluble activator is 4:1, the soluble activator is added into water, followed by stirring uniformly and standing for more than 2 hours (h) to obtain a pre-added solution with a concentration of 200 grams per liter (g/L), the undersize particles obtained in the step 1 are mixed with the pre-added solution, and the pre-added solution mixed with the undersize particles is stirred by using a high-speed disperser to obtain a prepared slurry. Specially, a stirring speed of the high-speed disperser is 3,000 revolutions per minute (rpm), and a time for the stirring in the step 2 is 20 minutes (min).

Step 3, high-pressure activation: the prepared slurry obtained in the step 2 is added in a reaction kettle for the high-pressure activation to obtain activated mixed slurry. Specially, a temperature of the high-pressure activation in the step 3 is 120 degrees Celsius (° C.); a pressure of the high-pressure activation in the step 3 is 0.2 megapascals (MPa); and a time for maintaining the pressure is 2 h.

Step 4, slurry sand separation: the activated mixed slurry obtained in the step 3 is sieved through a 180-mesh sieve to obtain the active slurry and sieve residues, and the sieve residues are used to prepare the construction solid waste-based recycled sand.

A method for preparing the construction solid waste-based geopolymer cementitious material includes the following steps.

Step 1, amounts of the active slurry and the compensator are calculated respectively according to design requirements of the construction solid waste-based geopolymer cementitious material. Specially, the compensator is a mixture of the fly ash and the gasification slag, and a mass ratio of the fly ash to the gasification slag in the mixture is 1:1; a mass ratio of the active slurry to the compensator is 1.1:1; and the compensator is subjected to ball-milling pretreatment until a gradation of the compensator is less than 180 meshes for later use.

Step 2, the active slurry is weighed according to the amount calculated in the step 1, the active slurry is pre-stirred by using a disperser for 30 seconds (s), and then the compensator containing the fly ash and the gasification slag is added into the active slurry to continue stirring for 10 min to prepare the construction solid waste-based geopolymer cementitious material.

Specially, the construction solid waste-based geopolymer cementitious material is used for preparing the construction material for the roadbed and the pavement within 3 min; otherwise, the construction solid waste-based geopolymer cementitious material is stirred for 5 min again at a rotating speed of 1,800 rpm, and then used for preparing the construction material for the roadbed and the pavement.

During preparing the high-strength railway sleeper, a mass ratio of the aggregates to the construction solid waste-based geopolymer cementitious material is 1.9:1, the aggregates include: stones with particle sizes of 5-10 mm and stones with particle sizes of 10-20 mm, a mass ratio of the stones with particle sizes of 5-10 mm to the stones with particle sizes of 10-20 mm is 3:7, and a sand to aggregate ratio of the high-strength railway sleeper is 0.5. Thereafter, a formed standard sample (i.e., the obtained high-strength railway sleeper) is cured for 7 days at a temperature of 20° C.±2° C. and a humidity of not less than 95%, and a compressive strength of the prepared high-strength railway sleeper can reach 60 MPa.

After detection, the high-strength railway sleeper prepared in the present embodiment meets requirements of a Chinese national standard titled “Sleeper for ballasted track-Concrete sleeper”, i.e., GB/T 37330-2019.

### Embodiment 2

Differences between the present embodiment and the embodiment 1 are that the construction material for the roadbed and the pavement is a road imitation brick; the compensator used in preparing the construction solid waste-based geopolymer cementitious material is a mixture of the gasification slag and the slag according to a mass ratio of the gasification slag to the slag of 3:1; a mass ratio of the active slurry to the compensator is 1.2:1; a mass ratio of the aggregates to the construction solid waste-based geopolymer cementitious material that are used in preparing the road imitation brick is 2.0:1; the aggregates include: stones with particle sizes of 3-5 mm; a sand to aggregate ratio of the road imitation brick is 0.8; and a curing condition of a formed standard sample (i.e., the obtained road imitation brick) is natural curing.

After detection, a compressive strength of the road imitation brick prepared in the present embodiment is not less than 40 MPa, and a flexural strength of the prepared road imitation brick is not less than 4.0 MPa, which both meet requirements of a Chinese national standard titled “Precast concrete paving units”, i.e., GB/T 28635-2012.

### Embodiment 3

Differences between the present embodiment and the embodiment 1 are that the construction material for the roadbed and the pavement is a road water-permeable brick; the compensator used in preparing the construction solid waste-based geopolymer cementitious material is the fly ash; a mass ratio of the active slurry to the compensator is 1.2:1; a mass ratio of the aggregates to the construction solid waste-based geopolymer cementitious material that are used in preparing the road water-permeable brick is 2.0:1; the aggregates include: stones with particle sizes of 8-15 mm; a sand to aggregate ratio of the road water-permeable brick is 0.4; and a curing condition of a formed standard sample (i.e., the obtained road water-permeable brick) is natural curing.

After detection, a flexural strength of the road water-permeable brick prepared in the present embodiment is not less than 3.0 MPa, a splitting tensile strength of the prepared road water-permeable brick is not less than 3.0 MPa, and a permeability coefficient of the prepared road water-permeable brick is not less than 1.0×10⁻² centimeter per second (cm/s), which all meet the requirements of the Chinese national standard titled “Precast concrete paving units”, i.e., GB/T 28635-2012.

### Embodiment 4

As shown in FIGURE, in the present embodiment, the subway shield soil and the construction waste soil in the construction solid wastes are used as raw materials to prepare a construction solid waste-based geopolymer cementitious material and construction solid waste-based recycled sand, a mass ratio of the subway shield soil to the construction waste soil 2:1, and then the construction solid waste-based geopolymer cementitious material and the construction solid waste-based recycled sand are subjected to batching, stirring, molding, and curing to obtain a high-strength railway sleeper.

Specially, active slurry used in the construction solid waste-based geopolymer cementitious material is prepared as follows.

Step 1, raw material screening: the raw materials in the construction solid wastes are screened through sieves with an each aperture of 1 mm to obtain undersize particles and oversize particles, and the oversize particles are used to obtain the construction solid waste-based recycled sand.

Step 2, stirring: barium hydroxide, hydrogen peroxide with a mass concentration of 6%, and sodium hydroxide are prepared as a soluble activator, a mass ratio of the barium hydroxide: the hydrogen peroxide: the sodium hydroxide in the soluble activator is 3:1:1, the soluble activator is added into water, followed by stirring uniformly and standing for more than 2 h to obtain a pre-added solution with a concentration of 200 g/L, the undersize particles obtained in the step 1 are mixed with the pre-added solution, and the pre-added solution mixed with the undersize particles is stirred by using a high-speed disperser to obtain a prepared slurry. Specially, a stirring speed of the high-speed disperser is 3,000 rpm, and a time for the stirring in the step 2 is 20 min.

Step 3, high-pressure activation: the prepared slurry obtained in the step 2 is added in a reaction kettle for the high-pressure activation to obtain activated mixed slurry. Specially, a temperature of the high-pressure activation in the step 3 is 140° C.; a pressure of the high-pressure activation in the step 3 is 0.4 MPa; and a time for maintaining the pressure is 2 h.

Step 4, slurry sand separation: the activated mixed slurry obtained in the step 3 is sieved through a 180-mesh sieve to obtain the active slurry and sieve residues, and the sieve residues are used to prepare the construction solid waste-based recycled sand.

A method for preparing the construction solid waste-based geopolymer cementitious material includes the following steps.

Step 1, amounts of the active slurry and the compensator are calculated respectively according to design requirements of the construction solid waste-based geopolymer cementitious material. Specially, the compensator is the fly ash; a mass ratio of the active slurry to the compensator is 1.2:1; and the compensator is subjected to ball-milling pretreatment until a gradation of the compensator is less than 180 meshes for later use.

Step 2, the active slurry is weighed according to the amount calculated in the step 1, the active slurry is pre-stirred by using a disperser for 30 s, and then the compensator containing the fly ash is added into the active slurry to continue stirring for 10 min to prepare the construction solid waste-based geopolymer cementitious material.

Specially, the construction solid waste-based geopolymer cementitious material is used for preparing the construction material for the roadbed and the pavement within 3 min; otherwise, the construction solid waste-based geopolymer cementitious material is stirred for 5 min again at a rotating speed of 1,800 rpm, and then used for preparing the construction material for the roadbed and the pavement.

During preparing the high-strength railway sleeper, a mass ratio of the aggregates to the construction solid waste-based geopolymer cementitious material is 2.3:1, the aggregates include: stones with particle sizes of 5-10 mm and stones with particle sizes of 10-20 mm, a mass ratio of the stones with particle sizes of 5-10 mm to the stones with particle sizes of 10-20 mm is 3:7, and a sand to aggregate ratio of the high-strength railway sleeper is 0.5. Thereafter, a formed standard sample (i.e., the obtained high-strength railway sleeper) is cured for 7 days at a temperature of 20° C.±2° C. and a humidity of not less than 95%, and a compressive strength of the prepared high-strength railway sleeper can reach 60 MPa.

After detection, the high-strength railway sleeper prepared in the present embodiment meets the requirements of the Chinese national standard titled “Sleeper for ballasted track-Concrete sleeper”, i.e., GB/T 37330-2019.

### Embodiment 5

Differences between the present embodiment and the embodiment 4 are that the construction material for the roadbed and the pavement is a road imitation brick; the compensator used in preparing the construction solid waste-based geopolymer cementitious material is the gasification slag; a mass ratio of the active slurry to the compensator is 1.3:1; a mass ratio of the aggregates to the construction solid waste-based geopolymer cementitious material that are used in preparing the road imitation brick is 2.0:1; the aggregates include: stones with particle sizes of 3-5 mm; a sand to aggregate ratio of the road imitation brick is 0.8; and a curing condition of a formed standard sample (i.e., the obtained road imitation brick) is natural curing.

After detection, a compressive strength of the road imitation brick prepared in the present embodiment is not less than 40 MPa, and a flexural strength of the prepared road imitation brick is not less than 4.0 MPa, which both meet the requirements of the Chinese national standard titled “Precast concrete paving units”, i.e., GB/T 28635-2012.

### Embodiment 6

Differences between the present embodiment and the embodiment 4 are that the construction material for the roadbed and the pavement is a road water-permeable brick; the compensator used in preparing the construction solid waste-based geopolymer cementitious material is the slag; a mass ratio of the active slurry to the compensator is 1.4:1; a mass ratio of the aggregates to the construction solid waste-based geopolymer cementitious material that are used in preparing the road water-permeable brick is 2.0:1; the aggregates include: stones with particle sizes of 8-15 mm; a sand to aggregate ratio of the road water-permeable brick is 0.4; and a curing condition of a formed standard sample (i.e., the obtained road water-permeable brick) is natural curing.

After detection, a flexural strength of the road water-permeable brick prepared in the present embodiment is not less than 3.0 MPa, a splitting tensile strength of the prepared road water-permeable brick is not less than 3.0 MPa, and a permeability coefficient of the prepared road water-permeable brick is not less than 1.0×10⁻² cm/s, which all meet the requirements of the Chinese national standard titled “Precast concrete paving units”, i.e., GB/T 28635-2012.

### Embodiment 7

As shown in FIGURE, in the present embodiment, the subway shield soil and the construction waste soil in the construction solid wastes are used as raw materials to prepare a construction solid waste-based geopolymer cementitious material and construction solid waste-based recycled sand, a mass ratio of the subway shield soil to the construction waste soil 5:1, and then the construction solid waste-based geopolymer cementitious material and the construction solid waste-based recycled sand are subjected to batching, stirring, molding, and curing to obtain a high-strength railway sleeper.

Specially, active slurry used in the construction solid waste-based geopolymer cementitious material is prepared as follows.

Step 1, raw material screening: the raw materials in the construction solid wastes are screened through sieves with an each aperture of 1 mm to obtain undersize particles and oversize particles, and the oversize particles are used to obtain the construction solid waste-based recycled sand.

Step 2, stirring: barium hydroxide, hydrogen peroxide with a mass concentration of 6%, and sodium hydroxide are prepared as a soluble activator, a mass ratio of the barium hydroxide: the hydrogen peroxide: the sodium hydroxide in the soluble activator is 5:1:2, the soluble activator is added into water, followed by stirring uniformly and standing for more than 2 h to obtain a pre-added solution with a concentration of 200 g/L, the undersize particles obtained in the step 1 are mixed with the pre-added solution, and the pre-added solution mixed with the undersize particles is stirred by using a high-speed disperser to obtain a prepared slurry. Specially, a stirring speed of the high-speed disperser is 3,000 rpm, and a time for the stirring in the step 2 is 20 min.

Step 3, high-pressure activation: the prepared slurry obtained in the step 2 is added in a reaction kettle for the high-pressure activation to obtain activated mixed slurry. Specially, a temperature of the high-pressure activation in the step 3 is 150° C.; a pressure of the high-pressure activation in the step 3 is 0.5 MPa; and a time for maintaining the pressure is 2 h.

Step 4, slurry sand separation: the activated mixed slurry obtained in the step 3 is sieved through a 180-mesh sieve to obtain the active slurry and sieve residues, and the sieve residues are used to prepare the construction solid waste-based recycled sand.

A method for preparing the construction solid waste-based geopolymer cementitious material includes the following steps.

Step 1, amounts of the active slurry and the compensator are calculated respectively according to design requirements of the construction solid waste-based geopolymer cementitious material. Specially, the compensator is a mixture of the fly ash, the gasification slag, and the slag, and a mass ratio of the fly ash: the gasification slag: the slag in the mixture is 2:1:1; a mass ratio of the active slurry to the compensator is 1.1:1; and the compensator is subjected to ball-milling pretreatment until a gradation of the compensator is less than 180 meshes for later use.

Step 2, the active slurry is weighed according to the amount calculated in the step 1, the active slurry is pre-stirred by using a disperser for 30 s, and then the compensator containing the fly ash, the gasification slag, and the slag is added into the active slurry to continue stirring for 10 min to prepare the construction solid waste-based geopolymer cementitious material.

Specially, the construction solid waste-based geopolymer cementitious material is used for preparing the construction material for the roadbed and the pavement within 3 min; otherwise, the construction solid waste-based geopolymer cementitious material is stirred for 5 min again at a rotating speed of 1,800 rpm, and then used for preparing the construction material for the roadbed and the pavement.

During preparing the high-strength railway sleeper, a mass ratio of the aggregates to the construction solid waste-based geopolymer cementitious material is 2.3:1, the aggregates include: stones with particle sizes of 5-10 mm and stones with particle sizes of 10-20 mm, a mass ratio of the stones with particle sizes of 5-10 mm to the stones with particle sizes of 10-20 mm is 3:7, and a sand to aggregate ratio of the high-strength railway sleeper is 0.5. Thereafter, a formed standard sample (i.e., the obtained high-strength railway sleeper) is cured for 7 days at a temperature of 20° C.±2° C. and a humidity of not less than 95%, and a compressive strength of the prepared high-strength railway sleeper can reach 60 MPa.

After detection, the high-strength railway sleeper prepared in the present embodiment meets the requirements of the Chinese national standard titled “Sleeper for ballasted track-Concrete sleeper”, i.e., GB/T 37330-2019.

### Embodiment 8

Differences between the present embodiment and the embodiment 7 are that the construction material for the roadbed and the pavement is a road imitation brick; the compensator used in preparing the construction solid waste-based geopolymer cementitious material is a mixture of the fly ash, the gasification slag, and the slag, and a mass ratio of the fly ash: the gasification slag: the slag is 2:1:1; a mass ratio of the active slurry to the compensator is 1.2:1; a mass ratio of the aggregates to the construction solid waste-based geopolymer cementitious material that are used in preparing the road imitation brick is 2.0:1; the aggregates include: stones with particle sizes of 3-5 mm; a sand to aggregate ratio of the road imitation brick is 0.8; and a curing condition of a formed standard sample (i.e., the obtained road imitation brick) is natural curing.

After detection, a compressive strength of the road imitation brick prepared in the present embodiment is not less than 40 MPa, and a flexural strength of the prepared road imitation brick is not less than 4.0 MPa, which both meet the requirements of the Chinese national standard titled “Precast concrete paving units”, i.e., GB/T 28635-2012.

### Embodiment 9

Differences between the present embodiment and the embodiment 7 are that the construction material for the roadbed and the pavement is a road water-permeable brick; the compensator used in preparing the construction solid waste-based geopolymer cementitious material is a mixture of the fly ash, the gasification slag, and the slag, and a mass ratio of the fly ash: the gasification slag: the slag is 2:1:1; a mass ratio of the active slurry to the compensator is 1.3:1; a mass ratio of the aggregates to the construction solid waste-based geopolymer cementitious material that are used in preparing the road water-permeable brick is 2.0:1; the aggregates include: stones with particle sizes of 8-15 mm; a sand to aggregate ratio of the road water-permeable brick is 0.4; and a curing condition of a formed standard sample (i.e., the obtained road water-permeable brick) is natural curing.

After detection, a flexural strength of the road water-permeable brick prepared in the present embodiment is not less than 3.0 MPa, a splitting tensile strength of the prepared road water-permeable brick is not less than 3.0 MPa, and a permeability coefficient of the prepared road water-permeable brick is not less than 1.0×10⁻² cm/s, which all meet the requirements of the Chinese national standard titled “Precast concrete paving units”, i.e., GB/T 28635-2012.

The above are only the illustrated embodiments of the present disclosure and are not intended to limit the present disclosure. Any simple modifications, variations, and equivalent changes made to the above illustrated embodiments according to the technical essence of the present disclosure shall still fall within the scope of the protection of the technical solution of the present disclosure.

What is claimed is:

1. A method for preparing a construction material for a roadbed and a pavement by using construction solid waste-based geopolymers, comprising the following steps:
preparing a construction solid waste-based geopolymer cementitious material and construction solid waste-based recycled sand by using construction solid wastes, and then preparing the construction material for the roadbed and the pavement by batching, stirring, molding, and curing the construction solid waste-based geopolymer cementitious material and the construction solid waste-based recycled sand with aggregates and water; and
wherein the construction material for the roadbed and the pavement comprises: a railway sleeper, a road imitation brick, and a road water-permeable brick.

2. The method for preparing the construction material for the roadbed and the pavement by using the construction solid waste-based geopolymers according to claim 1, wherein raw materials for preparing the construction solid waste-based geopolymer cementitious material and the construction solid waste-based recycled sand are obtained from subway shield soil or construction waste soil in the construction solid wastes; and
wherein mineral compositions in the raw materials comprise muscovite, phlogopite, montmorillonite, and quartz with a total mass content greater than 60%; and a mass content of silica (SiO₂) in chemical compositions of the raw materials is greater than 50%, and a mass content of aluminum oxide (Al₂O₃) in the chemical compositions of the raw materials is not less than 15%.

3. The method for preparing the construction material for the roadbed and the pavement by using the construction solid waste-based geopolymers according to claim 1, wherein the construction solid waste-based geopolymer cementitious material is prepared by batching, mixing, and stirring active slurry and a compensator; a soluble activator added in the active slurry is barium hydroxide and hydrogen peroxide, or barium hydroxide, hydrogen peroxide, and sodium hydroxide; and the compensator comprises: sodium ions, calcium ions, and aluminum ions; and
wherein the active slurry is prepared by the following steps:
step 1, raw material screening, comprising: screening the construction solid wastes through sieves with each aperture of 1 millimeters (mm) to obtain undersize particles and oversize particles, and using the oversize particles to obtain the construction solid waste-based recycled sand;
step 2, stirring, comprising: adding the soluble activator into water, uniformly stirring the water added with the soluble activator, and then standing for more than 2 hours (h) to obtain a pre-added solution with a concentration of 200 grams per liter (g/L), mixing the undersize particles obtained in the step 1 with the pre-added solution, and stirring the pre-added solution mixed with the undersize particles by using a high-speed disperser to obtain prepared slurry; wherein a stirring speed of the high-speed disperser is 3,000 revolutions per minute (rpm), and a time for the stirring in the step 2 is 20 minutes (min);
step 3, high-pressure activation, comprising: adding the prepared slurry obtained in the step 2 in a reaction kettle for the high-pressure activation to obtain activated mixed slurry; wherein a temperature of the high-pressure activation in the step 3 is in a range of 120 degrees Celsius (° C.) to 150° C.; a pressure of the high-pressure activation in the step 3 is in a range of 0.2 megapascals (MPa) to 0.5 MPa; and a time for maintaining the pressure is 2 h; and
step 4, slurry sand separation, comprising: sieving the activated mixed slurry obtained in the step 3 through a 180-mesh sieve to obtain the active slurry and sieve residues, and using the sieve residues to prepare the construction solid waste-based recycled sand.

4. The method for preparing the construction material for the roadbed and the pavement by using the construction solid waste-based geopolymers according to claim 3, wherein the compensator is prepared from at least one selected from the group consisting of gasification slag, fly ash, and slag, and a mass content of Al₂O₃ in the compensator is greater than 15%, a mass content of calcium oxide (CaO) in the compensator is greater than 10%, a mass content of sodium oxide (Na₂O) in the compensator is greater than 3%, and a gradation of the compensator is less than 180 mesh.

5. The method for preparing the construction material for the roadbed and the pavement by using the construction solid waste-based geopolymers according to claim 3, wherein a method for preparing the construction solid waste-based geopolymer cementitious material by batching, mixing, and stirring the active slurry and the compensator comprises the following steps:
step 1, respectively calculating amounts of the active slurry and the compensator according to design requirements of the construction solid waste-based geopolymer cementitious material, wherein a mass ratio of the active slurry to the compensator is in a range of 1.1-1.4:1; and
step 2, weighing the active slurry according to the amount of the active slurry calculated in the step 1, pre-stirring the active slurry by using a disperser for 30 seconds (s), and then adding the compensator into the active slurry to continue stirring for 10 min to prepare the construction solid waste-based geopolymer cementitious material;
wherein the construction solid waste-based geopolymer cementitious material is configured to prepare the construction material for the roadbed and the pavement within 3 min; or
wherein the construction solid waste-based geopolymer cementitious material is stirred for 5 min at a rotating speed of 1,800 rpm, and then is configured to prepare the construction material for the roadbed and the pavement.

6. The method for preparing the construction material for the roadbed and the pavement by using the construction solid waste-based geopolymers according to claim 3, wherein a mass ratio of the aggregates to the construction solid waste-based geopolymer cementitious material is in a range of 1.9-2.3:1;
wherein when the construction material for the roadbed and the pavement is the railway sleeper, the aggregates comprise: stones with particle sizes of 5-10 mm and stones with particle sizes of 10-20 mm, a mass ratio of the stones with particle sizes of 5-10 mm to the stones with particle sizes of 10-20 mm is 3:7, and a sand to aggregate ratio of the railway sleeper is 0.5, and the compensator used for preparing the construction solid waste-based geopolymer cementitious material is fly ash; or
wherein when the construction material for the roadbed and the pavement is the road imitation brick, the aggregates comprise: stones with particle sizes of 3-5 mm, a sand to aggregate ratio of the road imitation brick is 0.8, the compensator used for preparing the construction solid waste-based geopolymer cementitious material is gasification slag, and a curing condition for preparing the road imitation brick is natural curing; or
wherein when the construction material for the roadbed and the pavement is the road water-permeable brick, the aggregates comprise: stones with particle sizes of 8-15 mm, a sand to aggregate ratio of the road water-permeable brick is 0.4, the compensator used for preparing the construction solid waste-based geopolymer cementitious material is slag, and a curing condition for preparing the road water-permeable brick is natural curing.
